(19) United States
(12) Patent Application Publication
(10) Pub. No.: US 2013/0144602 A1
(43) Pub. Date: Jun. 6, 2013

(54) Quantitative Type Data Analyzing Device and Method for Quantitatively Analyzing Data

(71) Applicants: Kuo-Cheng YEU, New Taipei City (TW); Chien-Tsung LIU, Taipei City (TW); Yi-An TSAI, Taipei City (TW)

(72) Inventors: Kuo-Cheng YEU, New Taipei City (TW); Chien-Tsung LIU, Taipei City (TW); Yi-An TSAI, Taipei City (TW)

(73) Assignee: INSTITUTE FOR INFORMATION INDUSTRY, TAIPEI (TW)

(21) Appl. No.: 13/316,570

(22) Filed: Dec. 12, 2011

(30) Foreign Application Priority Data
Dec. 2, 2011 (TW) 100144373

(51) Int. Cl. G06F 17/27

(52) U.S. Cl. 704/9

(57) ABSTRACT

A method for quantitatively analyzing data is applied to a computer system for determining whether a document under test is sensitive. The method obtains sample message from the computer system, partitions content of the sample message to derive at least one original paragraph. The method then partitions the original paragraph to derive original sentences and to derive a plurality of original sentence characteristics from the original sentences. After that, the method produces the feature vector according to the derived sentence characteristics.

### RELATED APPLICATIONS

This application claims priority to Taiwan Application Serial Number 100144373, filed Dec. 2, 2011, which is herein incorporated by reference.

### BACKGROUND

1. Field of Invention

The present invention relates to a method for quantitatively analyzing data. More particularly, the present invention relates to a method for quantitatively analyzing data related to information security.

2. Description of Related Art

In recent years, some researches have commented that losses caused by information leakages from business entities are more than 1 trillion; some studies also revealed that the information leakages in 2011 is more than five times of that in 2010. Employees unconsciously letting out confidential information or stealing the confidential information have played important roles in security issues.

In order to protect important information, many companies have adopted a information security control system to monitor a variety of information within the companies, which prevents serious damages caused by the information leakage. In general, the information security management system of these companies usually controls and records write permissions to computer files, CD recording behavior, file printing actions, software/hardware usage, web browser access, network accesses, and the inquiries, such that the computer information of the companies can be controlled.

However, most of the current security control system adapted by the companies can not accurately discover the documents requiring protection, result in that personal files of employees might be processed as the confidential documents, which bothers the employees a lot In addition, the current security control system requires enormous resource to monitor the documents of the companies, which wastes too much human resource and material resource.

### SUMMARY

According to one embodiment of the present invention, a method for quantitatively analyzing data applied to a computer system for determining whether a document under test is sensitive is disclosed. The method obtains sample message from the computer system, partitions contains of the sample message to derive at least one original paragraph, and partitions the original paragraph to derive a plurality of original sentences. The method also derives a plurality of original sentence characteristics from the original sentences and produces a plurality of training feature vectors according to the derived original sentence characteristics which determines the sensitivity of the document under test.

According to another embodiment of the present invention, a quantitative type data analyzing device embedded in an electronic device for determining whether a document under test or an application program interface under execution is sensitive is disclosed.

The quantitative type data analyzing device includes a context feature extractor and an adjacent similar feature finder. The context feature extractor includes a data extractor, a data partition device, and a sentence analyzer. The data extractor derives a sample message or a document under test and respectively extracts an original message or an under test message from the sample message or the document under test. The data partition device partitions contents of the original message or the under test message to derive at least one original paragraph or at least one under test paragraph, and the data partition device also partitions the original paragraph or the under test paragraph to derive a plurality of original sentences or a plurality of under test sentences.

The sentence analyzer extracts a plurality of original sentence characteristics or a plurality of test sentence characteristics from the original sentences or the under test sentences, and the sentence analyzer also produces a plurality of training feature vectors or a plurality of testing feature vectors according to the original sentence characteristics or the test sentence characteristics. The adjacent similar feature finder determines whether the document under test is sensitive according to the testing feature vectors, the training feature vector, and a threshold of diversity.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 shows a flowchart of a method for quantitatively analyzing data according to one embodiment of the present invention;

FIG. 2A, FIG. 2B, and FIG. 2C show flowcharts of a method for quantitatively analyzing data according to two embodiments of the present invention;

FIG. 3 shows an illustration diagram of feature vectors according to one embodiment of the present invention;

FIG. 4 shows a block diagram of a quantitative type data analyzing device according to one embodiment of the present invention; and

FIG. 5A, FIG. 5B, and FIG. 5C show application diagrams of an electronic device according to three embodiments of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The quantitative type data analyzing device and the method for quantitatively analyzing data of the following embodiments analyze the content of the documents through quantitatively referencing features of the previous paragraphs or the subsequent paragraphs, such that new documents or existing documents can be accurately analyzed. In addition, users can adjust the similarity threshold by himself/herself for classification, which makes the comparison more flexible.

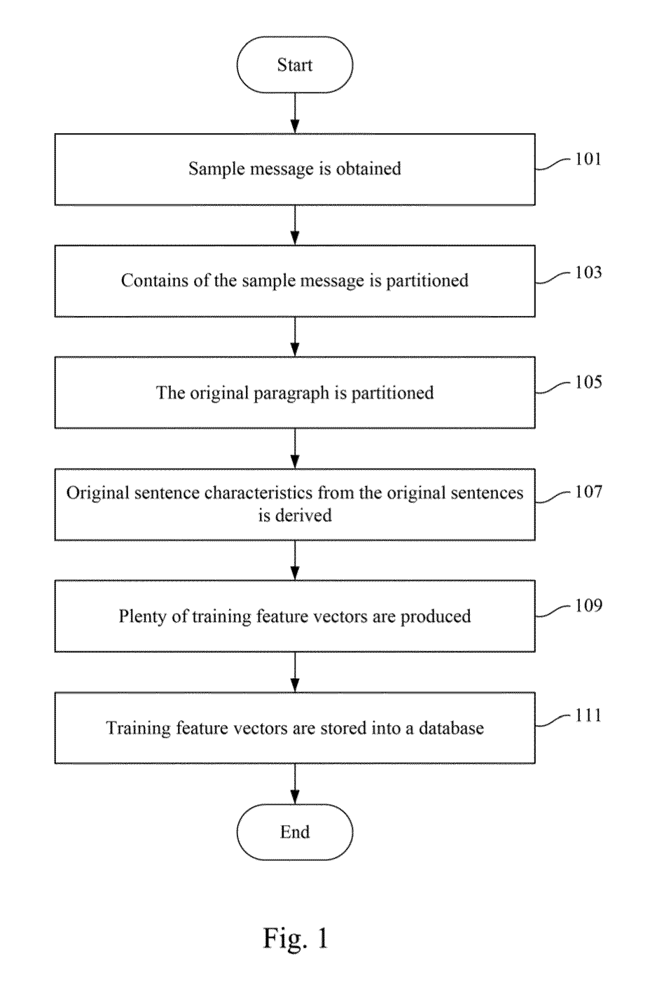

FIG. 1 shows a flowchart of a method for quantitatively analyzing data according to one embodiment of the ₚresent invention. The method is applied to a computer system for determining whether a document under test of the computer system is sensitive, in which the computer system can be a local area network computer system, an internet computer system, or a telephone computer system, etc. Sample message from the computer system is obtained by the method for quantitatively analyzing data first (step 101). For example, the method can search the database of the computer system for getting the documents which can not be let out, such as education documents, confidential business documents, business planning documents, specification documents, and business advertisements.

After getting the sample message, contains of the sample message is partitioned to derive at least one original paragraph (step 103), and the original paragraph is partitioned to derive a plurality of original sentences (step 105). In general, the method can partition the original paragraph based on the periods. For example, the appearance of one period represents an end of one sentence and a start of another sentence, such that the original paragraph can be partitioned into several sentences.

After step 105 derives the original sentences, several original sentence characteristics from the original sentences is derived (step 107), in which those sentence characteristics includes a number of words, a number of space, a number of commas, a number of quotes, a number of colon, a number of semicolon, a number of upper cases, and a number of numerals. In other words, the methods can respectively sum up the number of the words, the number of space, the number of commas, the number of quotes, the number of colon, the number of semicolon, the number of upper cases, and the number of numerals of one single sentence and get a total.

Subsequently, plenty of training feature vectors are produced according to the derived original sentence characteristics (step 109), in which the original sentence characteristics determines the sensitivity of the document under test. For instance, after deriving some feature vectors of the documents under test, those feature vectors can be compared with the training feature vectors, and the sensitivity of the document under test can be determined based on the difference obtained from the comparison of those feature vectors. After that, the training feature vectors are stored into a database of the computer system for accumulating the training feature vectors (step 111).

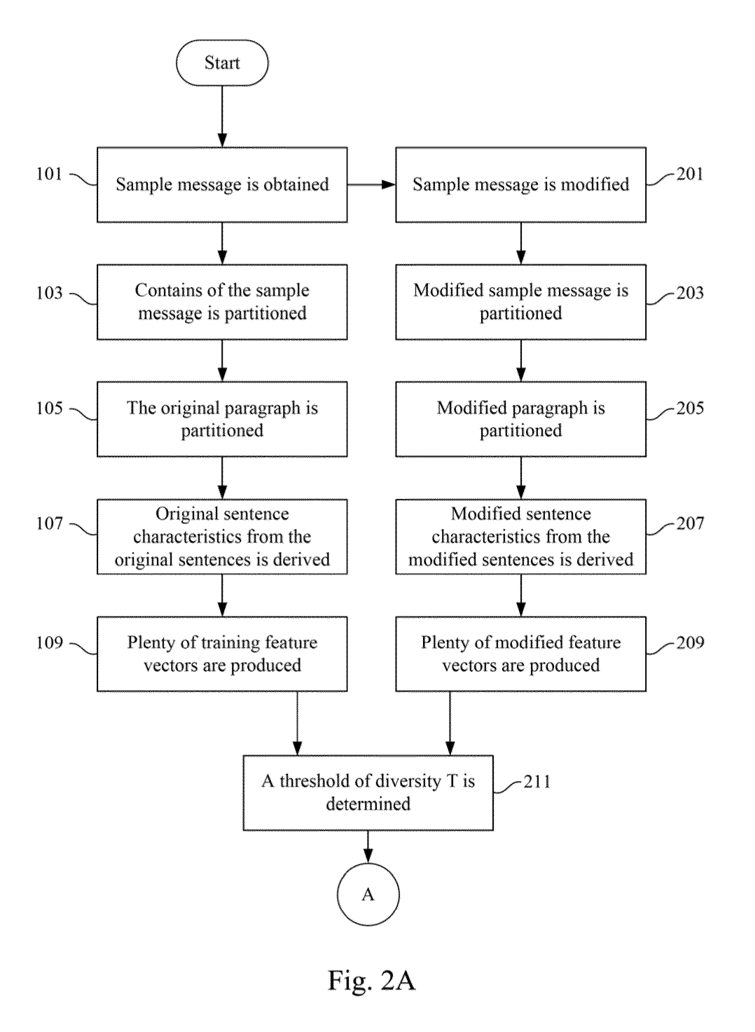

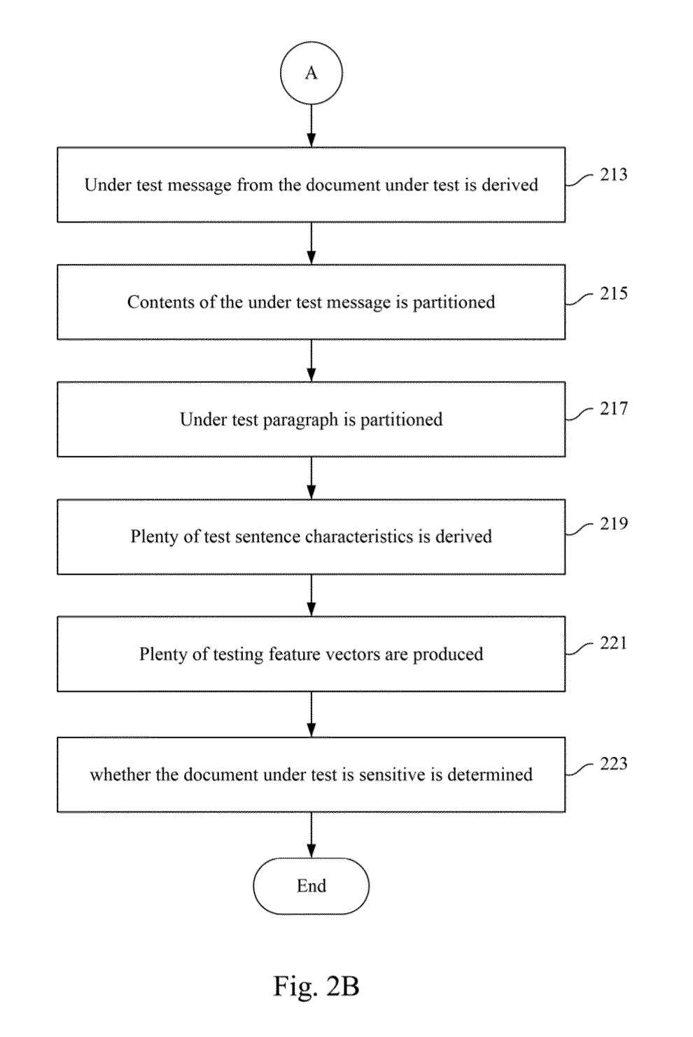

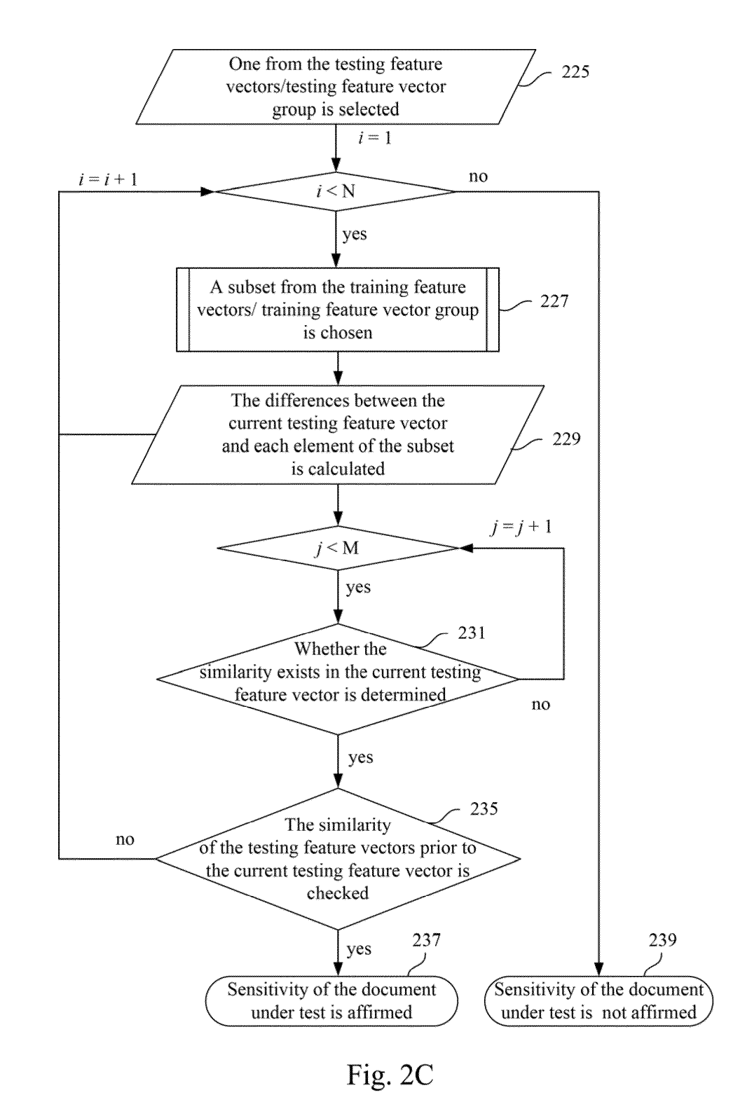

FIG. 2A, FIG. 2B, and FIG. 2C show flowcharts of a method for quantitatively analyzing data according to two embodiments of the present invention. In these embodiments, step 101˜step 109 which produce the training feature vectors are the same with those steps stated in FIG. 1. In addition to step 101˜step 109, step 201 to step 211 in this embodiment determine the threshold of diversity T which is one of the parameters determining the sensitivity of the document under test.

The sample message is first modified to derive a modified sample message (step 201). In detail, if the company or the business entity is strict with the confidential information, that is, the company still considers the document under test as the sensitive documents even if several differences exist between the document under test and the sample message, the sample message can be substantially modified to produce a threshold of diversity T with great tolerance.

After step 201, the modified sample message is partitioned to derive at least one modified paragraph (step 203), and the modified paragraph is partitioned to derive plenty of modified sentences (step 205). Next, plenty of modified sentence characteristics from the modified sentences is derived (step 207), and plenty of modified feature vectors are produced according to the derived modified sentence characteristics (step 209). The processes for producing the modified feature vectors and the training feature vectors are similar.

Finally, a threshold of diversity T is determined according to the difference between the training feature vectors and the modified feature vectors (step 211), in which the threshold of diversity T is used for determining whether the testing feature factors have the similarity. Specifically, by subtracting the training feature factor from the modified feature factor, an origin difference matrix can be obtained. The origin difference matrix is multiplied by a weight matrix to generate a quantify matrix. Then the threshold of diversity T is determined according to the value of the quantify matrix.

After getting the threshold of diversity T, the method continues to analyze the documents under test. There are two ways for analyzing the documents under test, respectively shown in FIG. 2B and FIG. 2C. As shown in FIG. 2B, a under test message from the document under test is derived (step 213), and contents of the under test message is partitioned to derive at least one under test paragraph (step 215). Next, the under test paragraph is partitioned to derive plenty of under test sentences (step 217), and plenty of test sentence characteristics is derived from the under test sentences (step 219). After that, plenty of testing feature vectors are produced according to the derived test sentence characteristics (step 221). Specifically, the methods for producing the testing feature vectors, the modified feature vectors, and the training feature vectors are the same. Those feature vectors represent the source sentence in certain ways while the sequences of those feature vectors correspond to the sequence of the appearing of the source sentences.

After step 221 getting the testing feature vectors, the testing feature vectors, the training feature vector, and the threshold of diversity T are individually compared to determine whether the document under test is sensitive (step 223). In detail, the method can sequentially and individually compute the differences between the elements of the testing feature vector group and the elements of the training feature vector group, as shown in FIG. 2C. In FIG. 2C, one from the testing feature vectors/testing feature vector group is selected as a current testing feature vector (step 225).

Next, a subset from the training feature vectors/training feature vector group is chosen based on the current testing feature vector and a range matrix R (step 227). The range matrix R is employed for initially choosing the subset similar to the value of the current testing feature vector, in which the individual element of the range matrix R is the difference of the corresponding feature vectors.

The differences (absolute value) between the elements of the testing feature vectors and the elements of the chosen training feature vectors should be less than the value of the corresponding elements of the parameter matrix R. For example, when the testing feature vector Q [3, 4, 5, 6, 7, 8, 9] having 3 as its first element is matched with the range matrix R [2, 10, 10, 10, 10, 10, 10], the proper range ranges from 1 to 5. In such condition, the training feature vector P₁₁ [1, 4, 5, 6, 7, 8, 9] complies with the requirement. On the other hand, the training feature vector P₁₂ [6, 3, 3, 6, 3, 3, 3] does not comply with the requirement because the difference between the first element (6) and the corresponding element of the testing feature vector exceeds 2, the first element of the range matrix R.

In step 227, the origin position of the chosen training feature vectors of the training feature vectors/training feature vector group should not be less than the position of the prior training feature vector having similarity found in previous cycles. However, the requirement can be exempted if no training feature vector having similarity is found in previous cycles.

After that, the differences between the current testing feature vector and each element of the subset is calculated (step 229), and whether the similarity exists in the current testing feature vector is determined according to the differences between the current testing feature vector and each element of the subset (step 231), in which the similarity is affirmed if the calculated difference is less than the threshold of diversity T.

When the similarity exists, the similarity of the testing feature vectors prior to the current testing feature vector is checked through referring to a adjacency margin A (step 235). If the similarity also exists in the prior testing feature vectors, a sensitivity of the document under test is affirmed (step 237) and the processes ends. Particularly, the sensitivity of the document under test is determined based on the testing feature vector, the training feature vector of the subset, and the adjacency margin A. If the difference of any two similar testing feature vectors is less than or equal to the adjacency margin A, the document under test is sensitive, and a positive value is returned (step 237).

On the other hand, if the differences of all testing feature vector having the similarity are greater than the adjacent margin A, the document under test is not sensitive, and the method will returns a negative value.

If the document under test is not sensitive, the method will select next testing feature vector as the current testing feature vector and repeats the above steps. If the steps in the aforesaid cycles cannot find any testing feature vector having similarity within adjacent margin A, the sensitivity of the document under test is not affirmed (step 239).

When sensitivity of the document under test is affirmed, the method can reject to deliver the sensitive document under test, delete the sensitive document under test, or do other process.

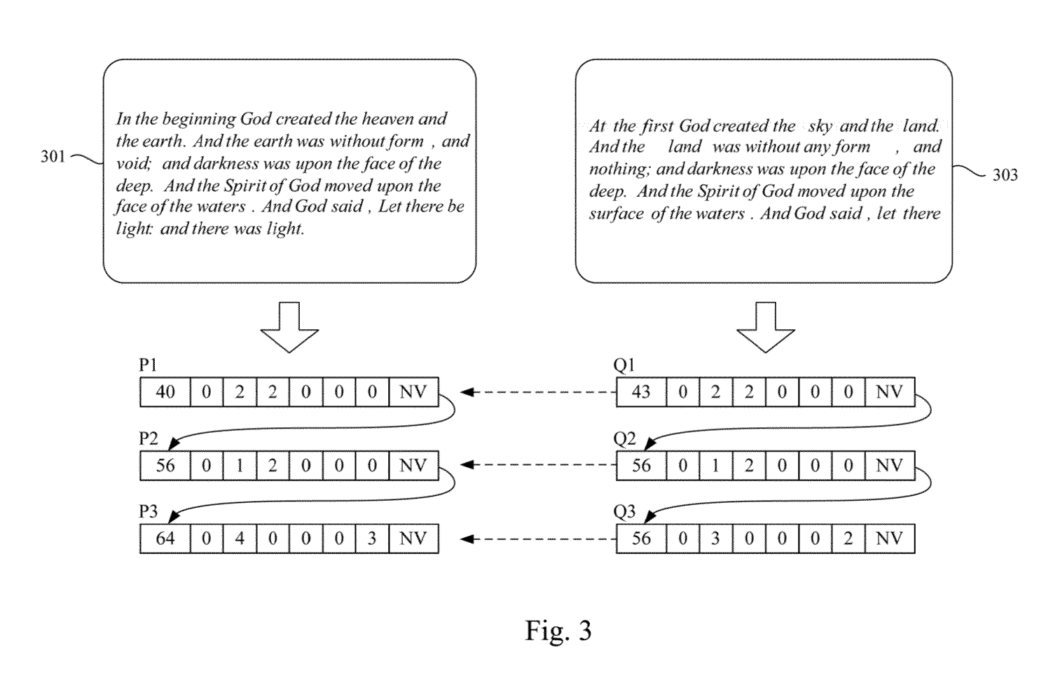

FIG. 3 shows an illustration diagram of feature vectors according to one embodiment of the present invention. As shown in FIG. 3, the training feature vectors P1, P2, P3 are derived through analyzing the sample message 301. After the sample message 301 is modified to derive the modified sample message 303, the modified feature vectors Q1, Q2, Q3 are derived through analyzing the modified sample message 303. Those feature vectors contain the message about the number of words, the number of space, the number of commas, the number of quotes, the number of colon, the number of semicolon, the number of upper cases, and the number of numerals.

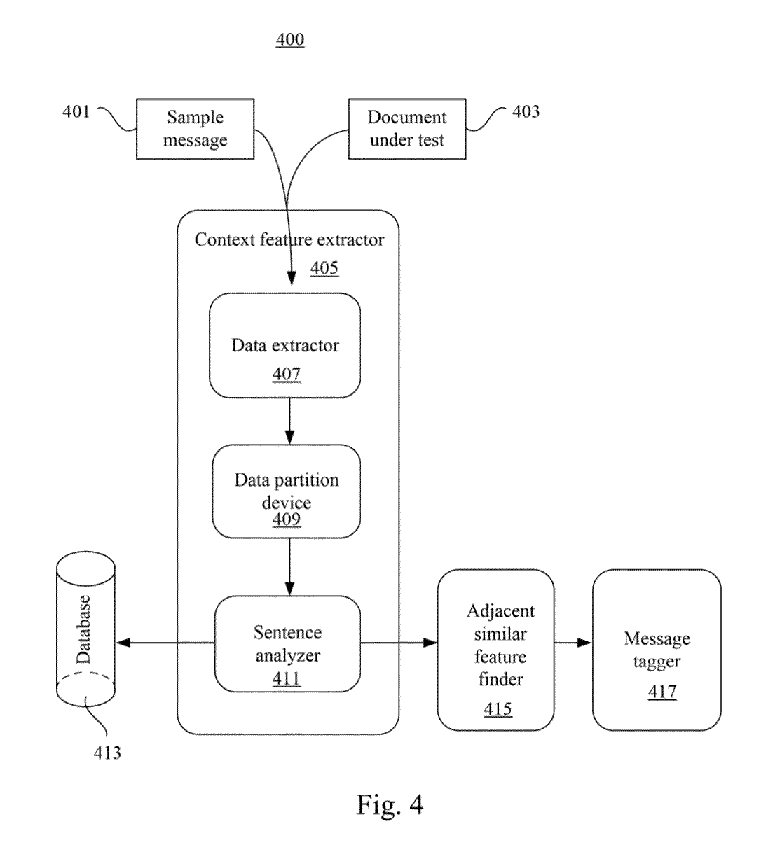

FIG. 4 shows a block diagram of a quantitative type data analyzing device according to one embodiment of the present invention. The quantitative type data analyzing device 400 embedded in an electronic device determines whether a document under test or an application program interface under execution is sensitive. The quantitative type data analyzing device 400 includes a context feature extractor 405, an adjacent similar feature finder 415, a message tagger 417, and a database 413. The context feature extractor 405 includes a data extractor 407, a data partition device 409, and a sentence analyzer 411.

The data extractor 407 derives a sample message 401 or a document under test 403 and respectively extracts an original message or an under test message from the sample message or the document under test. The data partition device 409 partitions contents of the original message or the under test message to derive at least one original paragraph or at least one under test paragraph. The data partition device 409 also partitions the original paragraph or the under test paragraph to derive plenty of original sentences or plenty of under test sentences.

The sentence analyzer 411 extracts plenty of original sentence characteristics or plenty of test sentence characteristics from the original sentences or the under test sentences; the sentence analyzer 411 also produces plenty of training feature vectors or plenty of testing feature vectors according to the original sentence characteristics or the test sentence characteristics.

The adjacent similar feature finder 415 determines whether the document under test is sensitive according to the testing feature vectors, the training feature vector, and a threshold of diversity T. When the adjacent similar feature finder 415 determines that the document under test is sensitive, the message tagger 417 marks the sensitive document under test. For example, the document can be marked as confidential for preventing from letting out. In addition to marking the document, the message tagger 417 can further process the sensitive document under test. For example, the message security system can be informed to reject the delivering of the document under test or to delete the document under test.

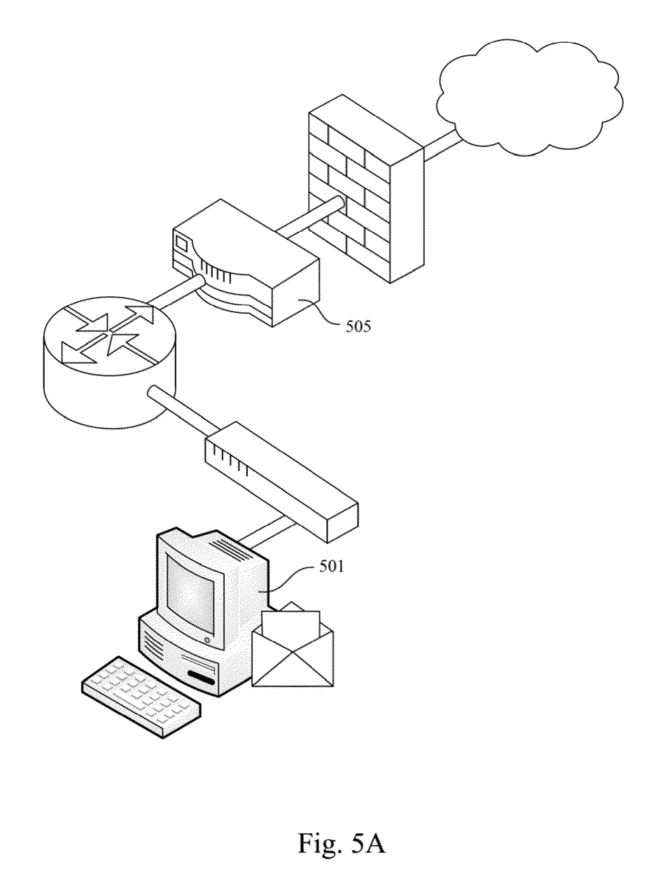

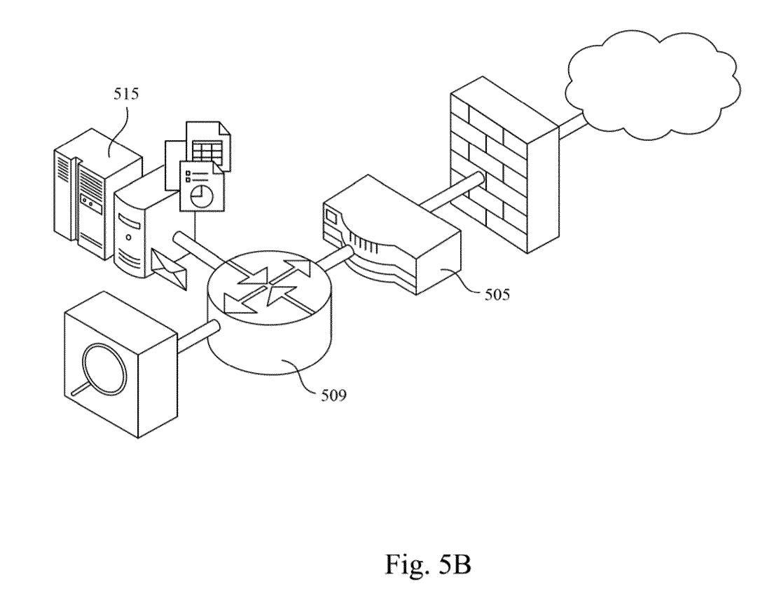

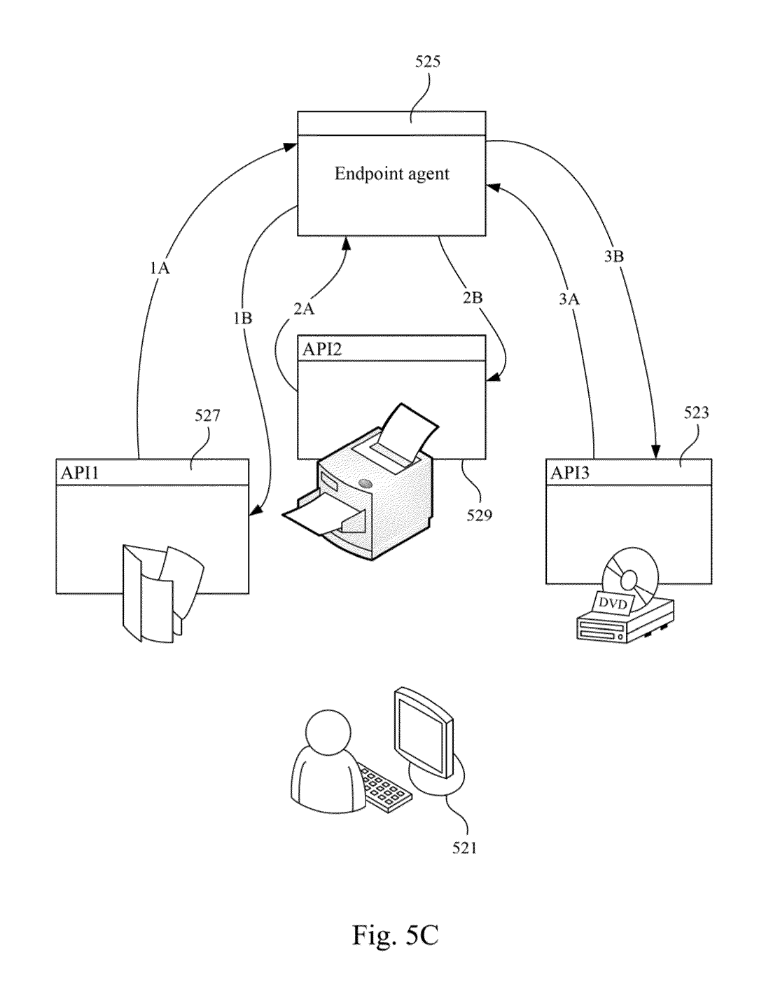

FIG. 5A, FIG. 5B, and FIG. 5C show application diagrams of an electronic device according to three embodiments of the present invention. The quantitative type data analyzing device mentioned above is embedded in those electronic devices for determining whether the document under test or the executing application program is sensitive.

In the embodiment shown in FIG. 5A, the electronic device is a security gateway 505 responsible for the document under test passed from personal computers to internet in order to determine whether the document under test is sensitive. For example, the security gateway 505 monitors the outgoing emails from the personal computer 501 to check if files attached to the outgoing emails are sensitive. If the files are sensitive, the security gateway 505 can intercept the emails to prohibit the emails from outgoing.

In the embodiment shown in FIG. 5B, the electronic device is a data explorer of the network node 509. The data explorer which determines whether the document under test contained in a host computer 515 or a server of a local area network is sensitive. The data explorer will check if the services provided by the host computer 515 violate the rules of the company or the business entity. For example, the data explorer checks if the host computer 515 improperly provides a network neighborhood or a sharing application for sharing files.

In the embodiment shown in FIG. 5C, the electronic device is a endpoint agent 525 which monitors and intercepts plenty of application program interfaces related to file accessing based on user behavior, such as a file opening application program interface 527, a file printing application program interface 529, and a file recording application program interface 523. If users perform the file access action stated above, the endpoint agent 525 will intercept file being accessed from an application program interface parameter and quantitatively analyzes the accessed file. If the accessed file is determined to be sensitive, the accessed file is further processed according to the policy of the company. If the accessed file is not sensitive, the original operation is retained.

The quantitative type data analyzing device and the method for quantitatively analyzing data of the above embodiments do the analysis based on the content of the document and through quantitatively referencing features of the previous paragraphs or the subsequent paragraphs, such that new documents or modified existing documents can be accurately analyzed. Mistakes caused by a single keyword can be prevented.

In addition, users can adjust the threshold of diversity and the searching scope through the efficiency options according to the hardware property and the system resource. Users can also set up the similarity threshold for classification, which makes the comparison more flexible. Furthermore, the quantitative type data analyzing device and the method for quantitatively analyzing data of the above embodiments can derive the quantitative paragraph feature from the sensitive document to be the basis for the further adjustment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for quantitatively analyzing data applied to a computer system for determining whether a document under test is sensitive, the method comprising:
obtaining sample message from the computer system;
partitioning contains of the sample message to derive at least one original paragraph;
partitioning the original paragraph to derive a plurality of original sentences;
deriving a plurality of original sentence characteristics from the original sentences; and
producing a plurality of training feature vectors according to the derived original sentence characteristics which determines the sensitivity of the document under test.

2. The method for quantitatively analyzing data as claimed in claim 1, further comprising:
storing the training feature vectors into a database of the computer system for accumulating the training feature vectors.

3. The method for quantitatively analyzing data as claimed in claim 2, further comprising:
modifying the sample message to derive a modified sample message;
partitioning the modified sample message to derive at least one modified paragraph;
partitioning the modified paragraph to derive a plurality of modified sentences;
deriving a plurality of modified sentence characteristics from the modified sentences; and
producing a plurality of modified feature vectors according to the derived modified sentence characteristics; and
determining a threshold of diversity according to the training feature vectors and the modified feature vectors.

4. The method for quantitatively analyzing data as claimed in claim 3, further comprising:
deriving a under test message from the document under test;
partitioning the under test message to derive at least one under test paragraph;
partitioning the under test paragraph to derive a plurality of under test sentences;
deriving a plurality of test sentence characteristics from the under test sentences; and
producing a plurality of testing feature vectors according to the derived test sentence characteristics; and
determining whether the document under test is sensitive according to the testing feature vectors, the training feature vector, and the threshold of diversity.

5. The method for quantitatively analyzing data as claimed in claim 4, wherein whether the document under test is sensitive is determined according to magnitude of the threshold of diversity and magnitude of a difference vector derived from subtracting the training feature vector from the testing feature vector.

6. The method for quantitatively analyzing data as claimed in claim 4, wherein the test sentence characteristics comprises a number of words, a number of space, a number of commas, a number of quotes, a number of colon, a number of semicolon, a number of upper cases, and a number of numerals.

7. The method for quantitatively analyzing data as claimed in claim 3, further comprising:
deriving a under test message from the document under test;
partitioning contents of the under test message to derive at least one under test paragraph;
partitioning the under test paragraph to derive a plurality of under test sentences;
deriving a plurality of test sentence characteristics from the under test sentences; and
producing a plurality of testing feature vectors according to the derived test sentence characteristics;
selecting one from the testing feature vectors as a current testing feature vector;
choosing a subset from the training feature vectors according to the current testing feature vector;
calculating the differences between the current testing feature vector and each element of the subset;
determining whether the similarity exists in the current testing feature according to the differences between the current testing feature vector and each element of the subset;
when the similarity exists, checking if the similarity also exists in the testing feature vectors prior to the current testing feature vector through referring to a adjacency margin; and
when the similarity also exists in the testing feature vectors prior to the current testing feature vector, affirming a sensitivity of the document under test.

8. The method for quantitatively analyzing data as claimed in claim 7, wherein the subset similar to the current testing feature vector is chosen according to the current testing feature vector and a range matrix.

9. The method for quantitatively analyzing data as claimed in claim 7, further comprising returning a positive value when the sensitivity of the document under test is affirmed.

10. The method for quantitatively analyzing data as claimed in claim 7, further comprising returning a negative value when the sensitivity of the document under test is not affirmed.

11. A quantitative type data analyzing device embedded in an electronic device for determining whether a document under test or an application program interface under execution is sensitive, the quantitative type data analyzing device comprising:
a context feature extractor comprising:
a data extractor for deriving a sample message or a document under test and for respectively extracting an original message or an under test message from the sample message or the document under test;
a data partition device for partitioning contents of the original message or the under test message to derive at least one original paragraph or at least one under test paragraph, and for partitioning the original paragraph or the under test paragraph to derive a plurality of original sentences or a plurality of under test sentences; and
a sentence analyzer for extracting a plurality of original sentence characteristics or a plurality of test sentence characteristics from the original sentences or the under test sentences, and for producing a plurality of training feature vectors or a plurality of testing feature vectors according to the original sentence characteristics or the test sentence characteristics; and
an adjacent similar feature finder for determining whether the document under test is sensitive according to the testing feature vectors, the training feature vector, and a threshold of diversity.

12. The quantitative type data analyzing device as claimed in claim 11, further comprising a message tagger for marking the document under test when the document under test is determined to be sensitive by the adjacent similar feature finder.

13. The quantitative type data analyzing device as claimed in claim 11, wherein the electronic device is a security gateway which determines whether the document under test passed through a network is sensitive.

14. The quantitative type data analyzing device as claimed in claim 11, wherein the electronic device is a data explorer which determines whether the document under test contained in a host computer of a local area network is sensitive.

15. The quantitative type data analyzing device as claimed in claim 14, wherein the document under test explored by the data explorer is shared by a network neighborhood or a sharing application.

16. The quantitative type data analyzing device as claimed in claim 11, wherein the electronic device is a endpoint agent which monitors and intercepts a plurality of application program interfaces related to file accessing based on user behavior.
